(19) United States
(12) Patent Application Publication
(10) Pub. No.: US 2005/0105713 A1
(43) Pub. Date: May 19, 2005

(54) Intelligent telephone number dialer and method

(75) Inventors: Bradley Dee Carlson, Glendale, AZ (US); Joan Parkinson, Phoenix, AZ (US); David John Michel, Pompano Beach, FL (US); Jeffrey Clark Heidel, Glendale, AZ (US); Warren Wayne Stanberry, Desert Hills, AZ (US)

Correspondence Address: JENNINGS, STROUSS & SALMON, P.L.C., 201 E. WASHINGTON ST., 11TH FLOOR, PHOENIX, AZ, 85004, US

(73) Assignee: DIALTECH LLC

(21) Appl. No.: 10/996,860

(22) Filed: Nov. 23, 2004

Related U.S. Application Data
(63) Continuation-in-part of application No. 09/678,487, filed on Oct. 3, 2000.

(51) Int. Cl. H04M 7/00; H04M 1/00; H04M 3/00

(52) U.S. Cl. 379/350; 379/355.01

(57) ABSTRACT

A system and method for dialing a telephone number in the form of an area code, prefix, and suffix, where the user enters only the prefix and suffix is disclosed. The system and method correlate the entered prefix, and in some embodiments, one or more digits of the entered suffix to determine the appropriate area code. The system then returns the entire telephone number including the area code, prefix and suffix, which is then automatically dialed. In another embodiment, the system returns a menu of possible area codes for user selection. The system and method are preferably employed in a community area network, but are also applicable in any multiple area code geographic region.

### CROSS-REFERENCE TO RELATED APPLICATIONS

This application is a continuation-in-part of U.S. application Ser. No. 09/678,487 filed Oct. 3, 2000, currently pending in the United States Patent and Trademark Office.

### FIELD OF THE INVENTION

This invention relates generally to telephone number dialers and, more specifically, to an apparatus and method for automatically transmitting a ten or eleven-digit telephone number following entry by the user of only a three-digit prefix followed by a four-digit suffix of the telephone number, via a community network.

### BACKGROUND OF THE INVENTION

In recent years, various telephone companies have lobbied for more area codes within major metropolitan areas, so that today many major cities have two or more telephone area codes. As a result, instead of dialing seven digits as in the past to make a local call, users are now subjected to the inconvenience of dialing ten digits and, in some cases, eleven.

As cellular telephones, pagers, fax machines, handheld electronic devices, and other communication devices have grown in popularity, along with the increase in telecommuting, many Americans have two, three, or more phone lines just for themselves. As a result, all of the major cities in the U.S. have at least two or more telephone area codes, and the largest cities, such as New York and Los Angeles, have more than ten area codes in the metropolitan area.

As metropolitan areas grow and the number of lines per individual rises, more area codes must be added. However, although most calls remain within a local geographic area, users are required to dial an entirely different area code even when calling locations nearby, including within the same neighborhood or office building. Overall, 85-95% of calls are made within local areas, and, as such, the vast majority of all calls dialed in metropolitan areas currently require users to enter ten or eleven digits. In addition, as area codes are added or split, an individual user needs to be made aware of area code changes or give notification to others when such a change occurs. Currently, when such a split occurs, businesses and individuals will lose calls from users who cannot contact them, because they are unaware of the area code changes. The result is inefficiency, lost time, and lost money.

Thus, a system which provides users across a metropolitan area the option to dial only the prefix and suffix of the telephone number, without the area code, is desirable. Such a system has the benefit of fostering a sense of community across the metropolis, makes dialing faster, eliminates the stigma of having an undesirable area code, and limits the number of digits that individual users will have to remember or enter into their phones, particularly in emergency situations or while driving. In addition, seven digit dialing is desirable for users working on wireless devices such as laptop computers, handheld personal data assistants, and personal wireless communication devices across a geographic area.

Automatic telephone area code dialers are known in the prior art. Exemplary of this art is U.S. Pat. No. 5,895,896 to Rosen, directed to a telephone line prefix dialer for automatically transmitting a local area code as a prefix to a call made within the same area code. This prior art device is disadvantageous in that it has the capability of transmitting only a single predetermined area code, thus rendering it useless in today's metropolitan areas encompassing multiple area codes. Moreover, if the user of this device wishes to dial a number within an area code that is outside the single predetermined local area code, he or she must, within a short time following receipt of a dial tone, “flash” the line to inhibit the device from transmitting the predetermined local area code to thereby allow the user to manually enter a different area code. This is inconvenient and awkward for the user.

Another known prior art reference is U.S. Pat. No. 5,859,901 to Brendzel et al., directed to an intelligent call connection service that utilizes software and a database residing in a telephone utility central office switching center to automatically transmit an area code prefix to dialed telephone numbers, through analysis of the calling subscriber's calling pattern, taking into account the distance between the calling and called parties. This system relies totally on modification, at tremendous cost, of a telephone utility's central office switching equipment. Furthermore, broadband technology has been adopted over older switching devices as disclosed in Brendzel et al., and is currently the system used by the vast majority of the telecommunications devices in the U.S., including telephones, computers and internet, cable television and the like.

It would thus be advantageous to provide a device that would serve to automatically transmit the required area code, based on the telephone number prefix entered by the user, so that the user need then enter only the seven-digit telephone number and, in rare instances, a selection digit in the event the desired prefix is valid in multiple area codes. Such a device could be made to be connectable between an existing telephone and a telephone line outlet to which it is normally connected, could be incorporated into a conventional telephone, or could be incorporated into the telephone utility's central office switching equipment.

In addition, a low-cost broadband network service provided by a metropolitan area, city, county, rural area, Native American reservation, school or university system, or across other discrete geographic areas, run as a public or private utility would be advantageous in providing users with seven-digit dialing capabilities, for broadband telephone, cellular telephone, fax, cable, internet, wireless internet, personal data assistants, and other communications devices. Particularly desirable would be a service, based on a centralized community network, that automatically transmitted the required area code, based on the telephone number prefix, such that only the seven-digit telephone number would be required. The present invention is envisioned as an additional feature to offer users within existing private utilities, or as a solution for public municipalities to meet the growing need for communication across a metropolitan area.

### BRIEF DESCRIPTION OF THE DRAWINGS

FIG. 1 is an overall block diagram of circuitry employed in the intelligent telephone number dialer of the present invention.

FIG. 2 is a block diagram of the circuitry of FIG. 1 illustrating the addition of a display for allowing the user to view multiple area codes in which a telephone number prefix entered by a user is valid.

FIG. 3 is a block diagram of the circuitry of FIG. 1 illustrating the addition of a voice synthesizer for audibly indicating multiple area codes in which a telephone number prefix entered by a user is valid.

FIGS. 4A-E are a flow chart illustrating the steps of one embodiment of the intelligent telephone number dialing method of the present invention.

FIG. 5 is an overall flow chart illustrating the steps of embodiment of the intelligent telephone number dialing method of the present invention.

FIG. 6 is an overall flow chart illustrating one embodiment of a community network.

### DETAILED DESCRIPTION OF VARIOUS EMBODIMENTS

The present invention is directed to an apparatus and method for automatically dialing a ten or eleven-digit telephone number following entry by the user of only the three-digit prefix and four-digit suffix of the telephone number. In one embodiment, the present invention may be a separate device having the ability to decode Dual Tone Multiple Frequency (DTMF) tones and that is connected between an existing telephone set and a telephone line wall outlet. The device includes a microprocessor for receiving the decoded digits and comparing them to a multiplicity of digits stored therein as telephone number prefixes. Each stored prefix is associated with a particular area code, so that when a telephone number prefix is entered by the user, its associated area code is automatically transmitted before the seven digits representing the prefix and suffix of the telephone number entered by the user are transmitted. A switch within the device allows the telephone line to which the device is connected to be placed off-hook or on-hook. Selection software within the device selects one area code from a multiplicity of area codes associated with an entered three-digit telephone number prefix, based upon the entered four-digit suffix of that telephone number. A visual display device or a voice synthesizer provides an indication to the user that the prefix of the telephone number entered is associated with more than one area code, allowing the user to enter a single digit for the purpose of selecting the desired area code. The data stored in the device may be programmably changed or updated.

The apparatus and method of the present invention, as briefly described in the preceding paragraph, may alternatively be contained within a standard telephone set. In accordance with another alternative, the apparatus and method of the present invention may be incorporated within a cellular telephone. Minimizing the number of digits that must be entered into a cellular telephone by the user when driving improves safety by reducing the amount of time that the user is distracted from operating his or her vehicle. The existing alphanumeric display on today's cellular telephones serves to display the complete ten-digit telephone number after the user has entered the three-digit prefix and seven-digit suffix of that number so that the complete number may be verified before it is transmitted. Also the display, or sound synthesis, can present multiple area code selections and the user either presses the appropriate button, or speaks the appropriate number, which is interpreted by sound recognition. In accordance with a third alternative, the method of the present invention may be implemented within a telephone utility's switching center and other telephone utility systems as a software addition to existing user features. Doing so will enhance subscribers' acceptance of the ten or eleven-digit dialing requirement, since in most instances they need enter only seven digits and, in rare cases, a selection digit, when the entered prefix is valid in multiple area codes. Other applications of the present invention include telefax machines, personal computers, modems, etc.

The present invention is also directed to an apparatus and method for automatically dialing a ten or eleven-digit telephone number following entry by the user of only the three-digit prefix and four-digit suffix of the telephone number, and activated via keypad dialing, automated dialing, voice activated dialing, sound synthesis, touchtone dialing, relay or typed telephone systems for the hearing-impaired, or other dialing methods.

The present invention is also directed to an apparatus and method using a community based network such as Network Operation Center (“NOC”) for automatically dialing a ten or eleven-digit telephone number following entry by the user of only the three-digit prefix and four-digit suffix of the telephone number. In this embodiment, the NOC is used in combination with software, a searchable database of telephone numbers, and a memory, of which the NOC may access the database, software, and memory, or may have any or all of these components loaded onto the NOC.

As used herein, a ten-digit telephone number is one that includes a three-digit area code, followed by a three-digit prefix, and ending with a four-digit suffix. An eleven-digit telephone number is one that includes the digit one, followed by a three-digit area code, followed by a three-digit prefix, and ending with a four-digit suffix.

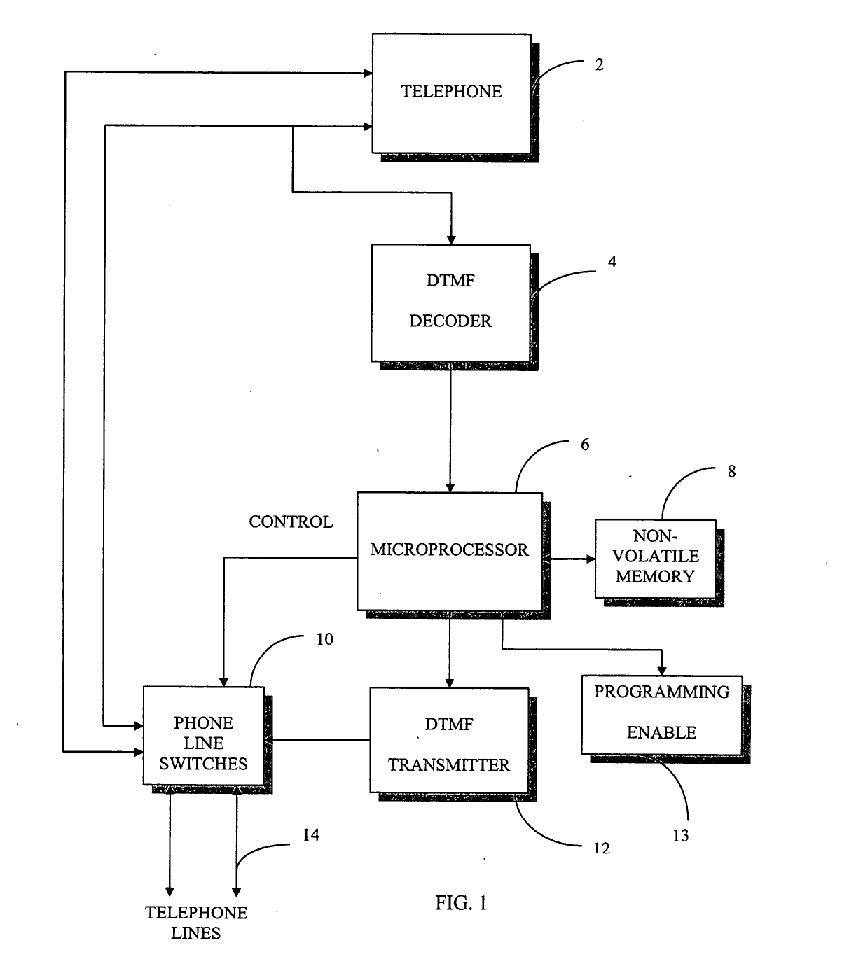

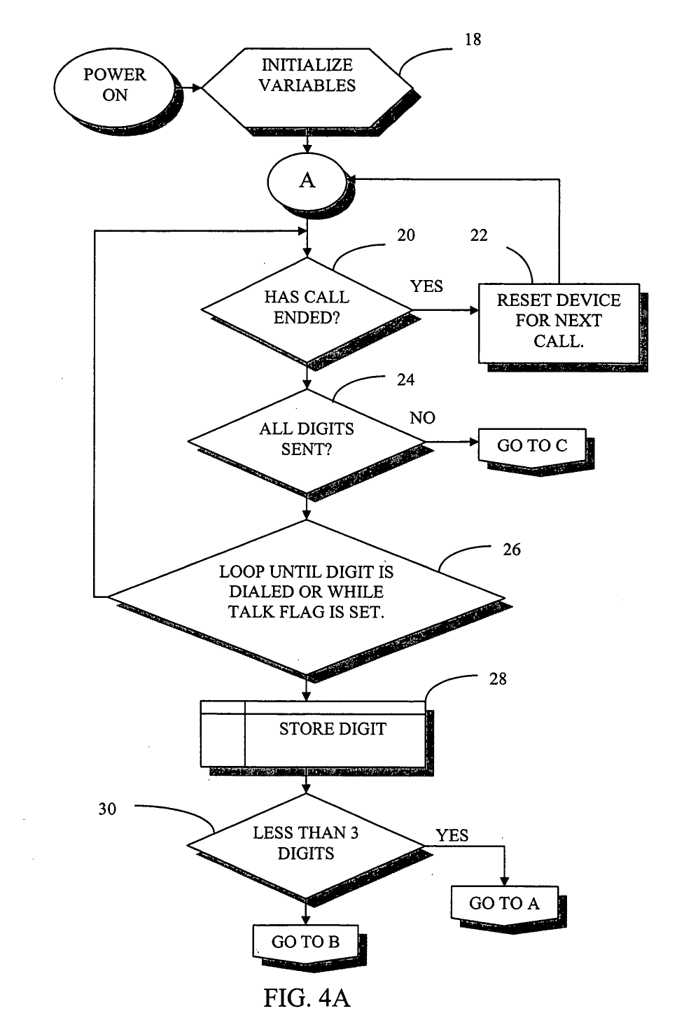

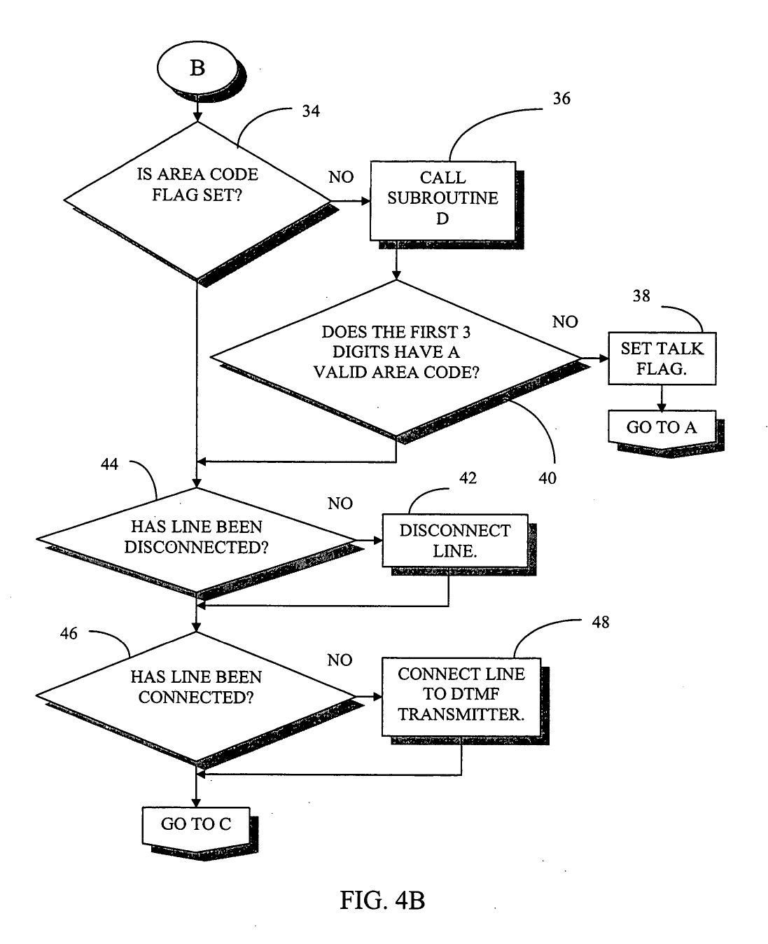

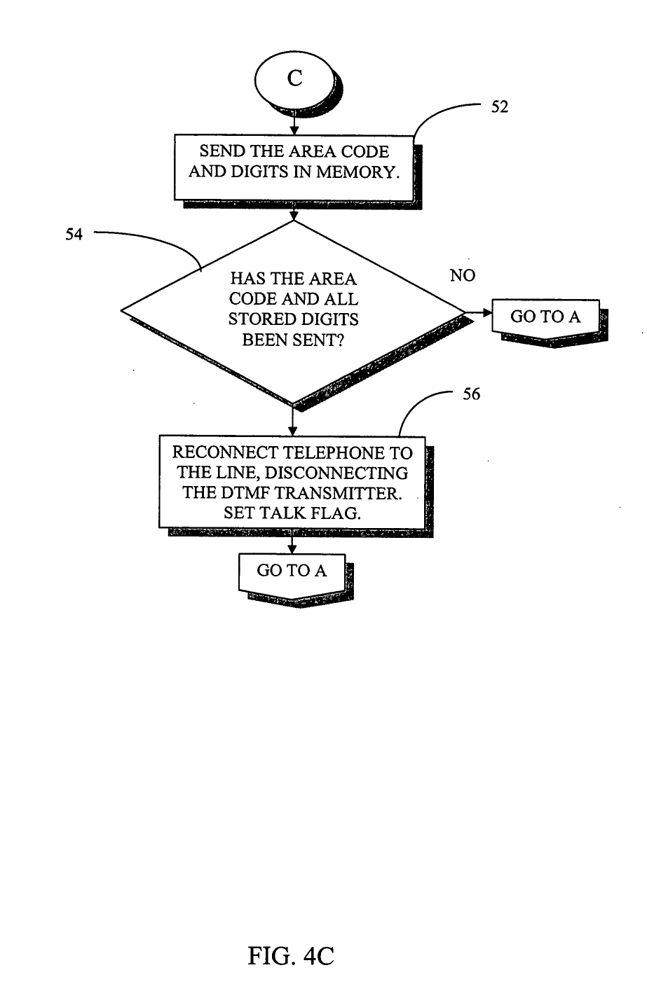

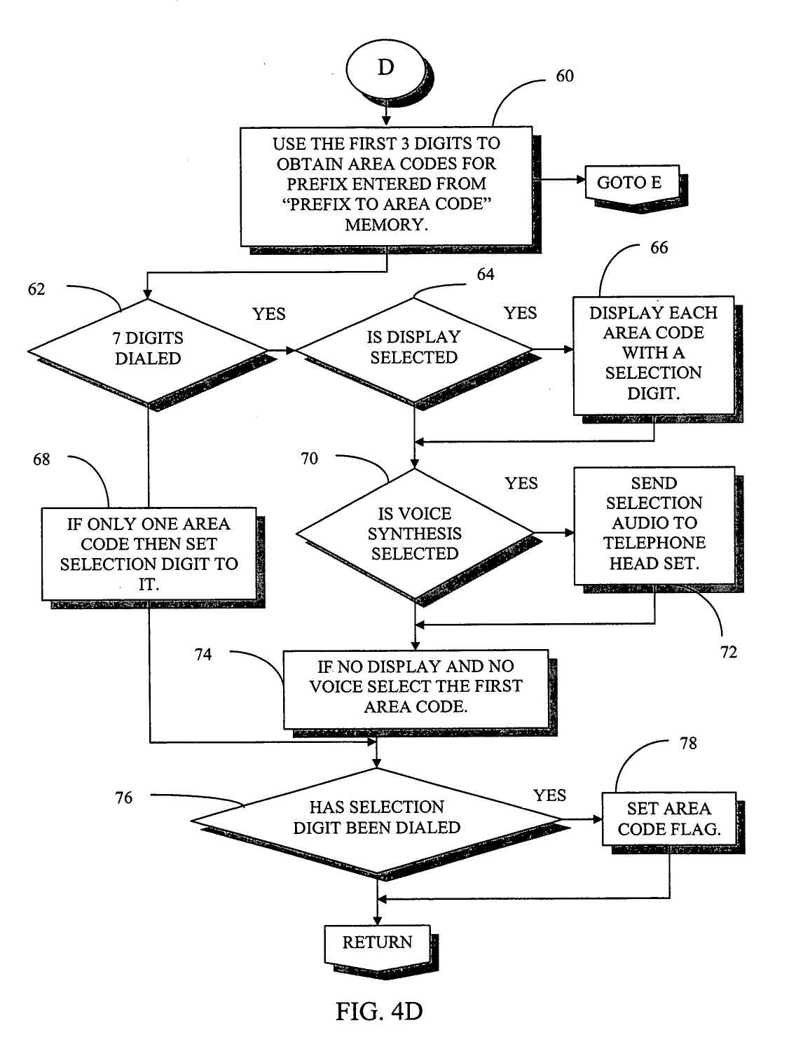

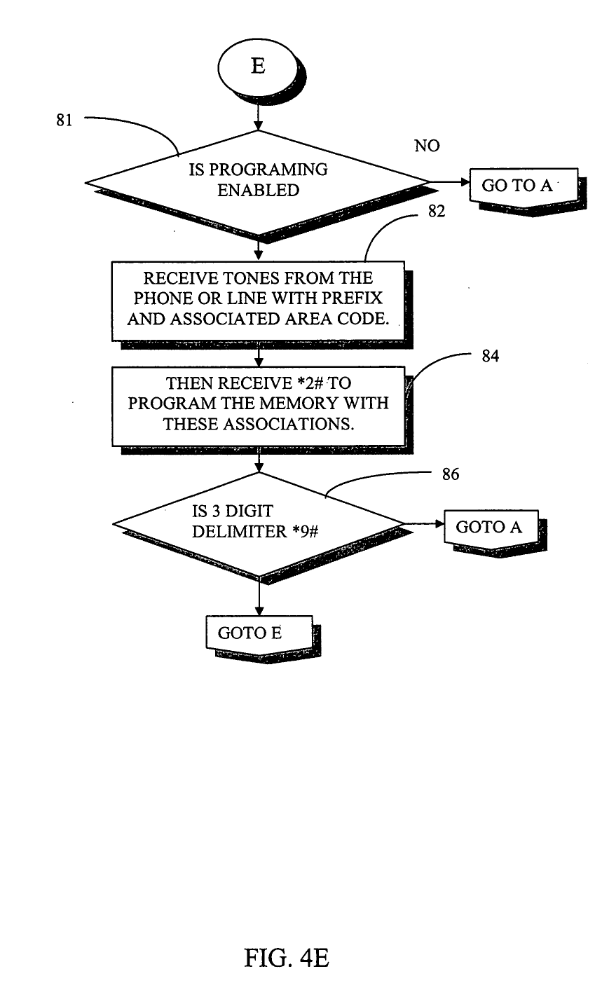

Referring now to FIG. 1, there are shown a conventional telephone instrument 2, a Dual Tone Multiple Frequency (DTMF) decoder 4, a microprocessor 6, a non-volatile memory 8, a telephone line switch block 10, a DTMF transmitter 12, a programming enabler 13, and an incoming telephone line 14. In the embodiment in which the intelligent telephone number dialer of the present invention is incorporated within conventional telephone 2, as opposed to being a separate device connected between conventional telephone 2 and incoming telephone line 14, the DTMF decoder 4 and the DTMF transmitter 12 would not be separately required, since these components form part of conventional telephone 2. In the embodiments in which the present invention is incorporated at a telephone utility's central office or within a cellular telephone, only a software implementation of the method steps of FIGS. 4A-E is required.

During a loss of power or failure of the circuitry of FIGS. 1-3, telephone 2 will operate normally. Memory 8 is preprogrammed with all of the three-digit telephone number prefixes and their associated area codes for a given geographical area. The data stored in memory 8 may be conventionally updated by downloading data from an internet site or over telephone lines.

During operation of the device of FIG. 1, the user employs telephone 2 to enter a seven-digit telephone number, which is received by microprocessor 6 through DTMF decoder 4 and temporarily stored in microprocessor 6. When microprocessor 6 determines that the first digit entered is not a 1, 0, or 9, and that the first three digits entered match a three-digit telephone number prefix stored in memory 8, microprocessor 6 enables switch block 10 to disconnect telephone 2 from telephone line 14 and to connect telephone 2 to an internal power supply to allow dialing to continue, while simulating an on-hook condition at telephone line 14. Following a short delay, microprocessor 6 again enables switch block 10 to take telephone line 14 off-hook and switch it to DTMF transmitter 12 for transmitting the area code retrieved from memory 8, followed by the associated three-digit prefix and the four-digit suffix entered by the user. When transmission of the entire ten-digit telephone number is complete, microprocessor 6 again enables switch block 10 to connect telephone line 14 to telephone 2 to allow the user to continue with the call.

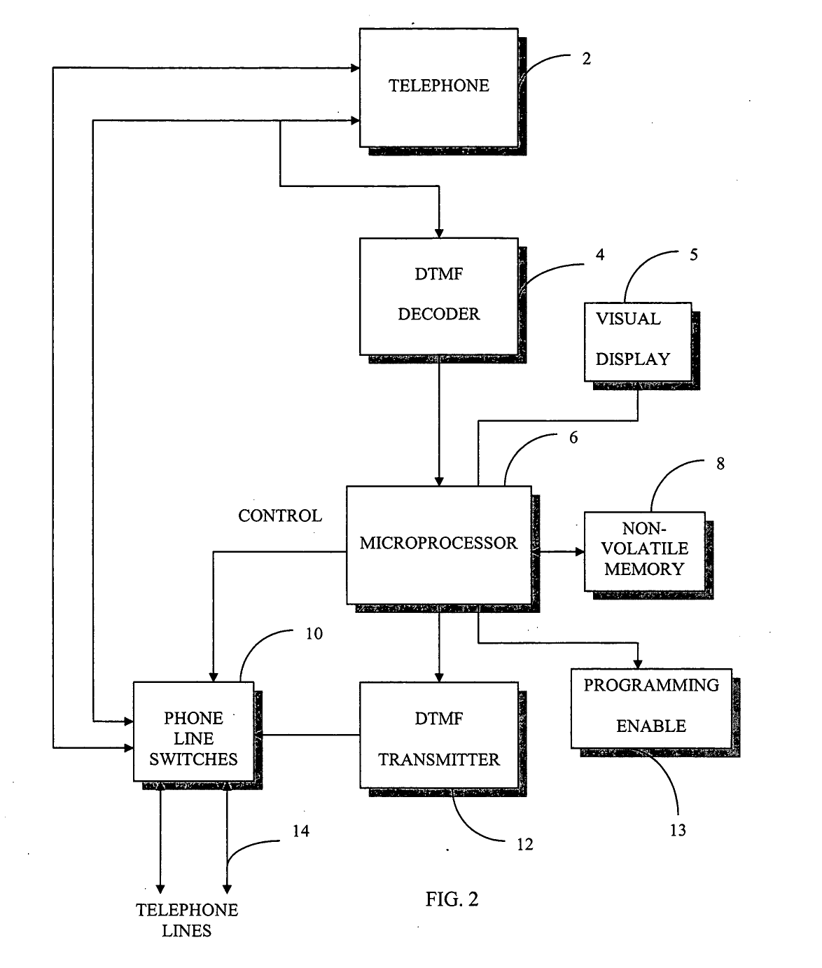

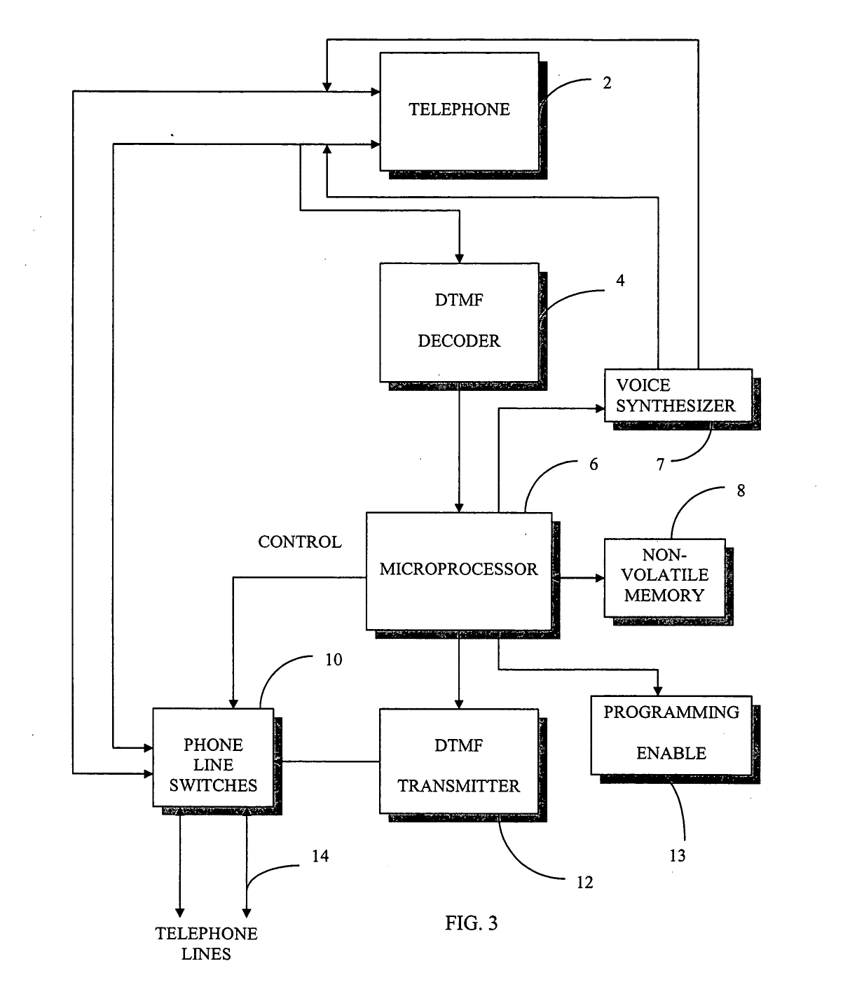

In certain geographic areas, the digit “1” must be entered as the first digit of the telephone number to be called. This is referred to as eleven-digit dialing. In this case, when a prefix entered by the user is detected by microprocessor 6 as one stored in memory 8, the digit 1 will be transmitted by DTMF transmitter 12 prior to transmitting the associated area code. If the user enters 1, 9, or 0 as the first digit of a telephone number to be called, or if the first three digits entered are not associated with an area code stored in memory 8, the call will be allowed to go through as entered by the user without any intervention. Programming enabler 13 allows the conventional updating of the database stored in memory 8 by switch activation, an off-hook condition in the absence of an incoming call, or by a specific sequence of digits. In the event the user enters a telephone number prefix that is valid in more than one area code, a display 5 illustrated in FIG. 2 is employed to display those area codes, along with an associated selection digit to be entered by the user for selecting a desired one of those area codes. Alternatively, the foregoing area code selection may be accomplished by means of a voice synthesizer, as illustrated in FIG. 3, which audibly alerts the user to the multiple area codes along with a digit to be entered to select the desired area code.

Referring now to FIGS. 4A-E, there is shown a flow chart of software functions performed by the intelligent telephone number dialer of FIGS. 1-3. When power is applied to the device, all variables, constants, and routines are initialized at block 18 to allow the device to sense an off-hook or on-hook condition in order to determine the start and finish of each telephone call at a decision block 20. If a call has ended, as indicated by an on-hook condition, then all variables, constants, and routines are reset for the next call at block 22. If a call has started, as indicated by an off-hook condition, then a test is performed at decision block 24 to determine if all digits have been entered by the user. If not, processing continues at point C of FIG. 4C. If so, then a loop 26 is entered until all digits have been entered. If a talk flag is set, the telephone is connected to the line without any intervention by the device. The loop 26 continues without interruption until the call has ended, as indicated by an on-hook condition determined at decision block 20. If the talk flag is not set, as determined by loop 26, each entered digit is stored in a temporary memory, in accordance with block 28, and a check is performed at decision block 30 to determine if three digits have been entered. If less than three digits have been entered, processing continues in the main loop beginning at point A. If the first digit entered is 0, then the talk flag is set to prevent intervention by the device. If three or more digits have been entered, processing continues at subroutine B of FIG. 4B.

Referring now to FIG. 4B, if an area code flag is not set, as determined at decision block 34, processing continues at subroutine D of FIG. 4D to retrieve the selected area code, as described hereinbelow. When subroutine D returns from a call check to determine if the first three digits entered are associated with a valid area code, a negative determination causes an area code flag to be set to invalid, the talk flag to be set at block 38, and processing to continue at main loop A. This condition usually indicates that the user has begun entering a number other than a seven-digit number having a valid prefix, such as a 1XX out-of-area number, a 911 emergency number, or some other invalid prefix number. If the first three digits entered are associated with a valid area code, a determination is made at decision block 44 as to whether the line has been disconnected from the DTMF transmitter following the correct number of program loops. If not, the line is disconnected at block 42. If the area code flag is set, as determined at decision block 34, and the line has been disconnected as the result of the correct number of program loops being performed, a determination is made at decision block 46 as to whether the line has been connected to the DTMF transmitter following the correct number of program loops. If the area code flag is not set, the line is connected at block 48. If the line has been previously connected to the DTMF transmitter following the correct number of program loops, then processing continues at point C of FIG. 4C.

Referring now to FIG. 4C, the next area code or the next digit stored in memory is sent in the proper sequence by the DTMF transmitter at block 52. If all area code digits and all stored digits have not been sent by the DTMF transmitter, as determined at decision block 54, the processing continues at the main loop beginning at point A of FIG. 4A. If all area code digits and all stored digits have been sent by the DTMF transmitter, as determined at decision block 54, the telephone is then reconnected to the line, the talk flag is set to prevent intervention by the device, and processing continues at the main loop beginning at point A of FIG. 4A.

Referring now to the subroutine of FIG. 4D, the first three digits entered are searched in memory, in accordance with block 60. If the first three digits entered are the symbol sequence *1#, processing continues at point E of FIG. 4E. If seven digits have been entered, as determined at decision block 62, the memory is searched at block 68 to determine if a unique area code is associated with the prefix portion of the seven-digit telephone number entered. If a display device is available and more than one area code is associated with the seven-digit number entered, those area codes are displayed, each with an associated selection digit to allow the user to select the desired area code, in accordance with block 66. If a display device is not available, a determination is made at decision block 70 as to whether a voice synthesizer is available. If yes, an audio message to enable the user to select the desired area code is sent to the telephone headset, in accordance with block 72. If neither a voice synthesizer nor a display device is available, the first area code found in memory is selected, in accordance with block 74. If fewer than seven digits have been entered by the user and only one area code is associated with the first three digits entered, the selection digit for that area code is set in accordance with block 68. If a selection digit has been entered by the user, as determined at decision block 76, the area code flag is set, in accordance with block 78, and processing is returned. If a selection digit has not been entered by the user, as determined at decision block 76, the area code flag is not set, and processing is returned.

Referring now to FIG. 4E, if memory programming is not enabled, as determined at decision block 81, the talk flag is set, and processing continues at point A of FIG. 4A. If memory programming is enabled, data may be received by the device over the telephone line that is representative of telephone number prefixes and their associated area codes, in accordance with block 82. The received data may include the digit 1 to indicate an out-of-area telephone number to thereby accommodate eleven-digit dialing when necessary. If a delimiter in the form of the symbol sequence *2# is received, the previously received data is then stored in memory, the talk flag is set, and processing continues at point A of FIG. 4A. If a delimiter in the form of the symbol sequence *9# is received, as determined at decision block 86, processing continues at point E for receiving additional data.

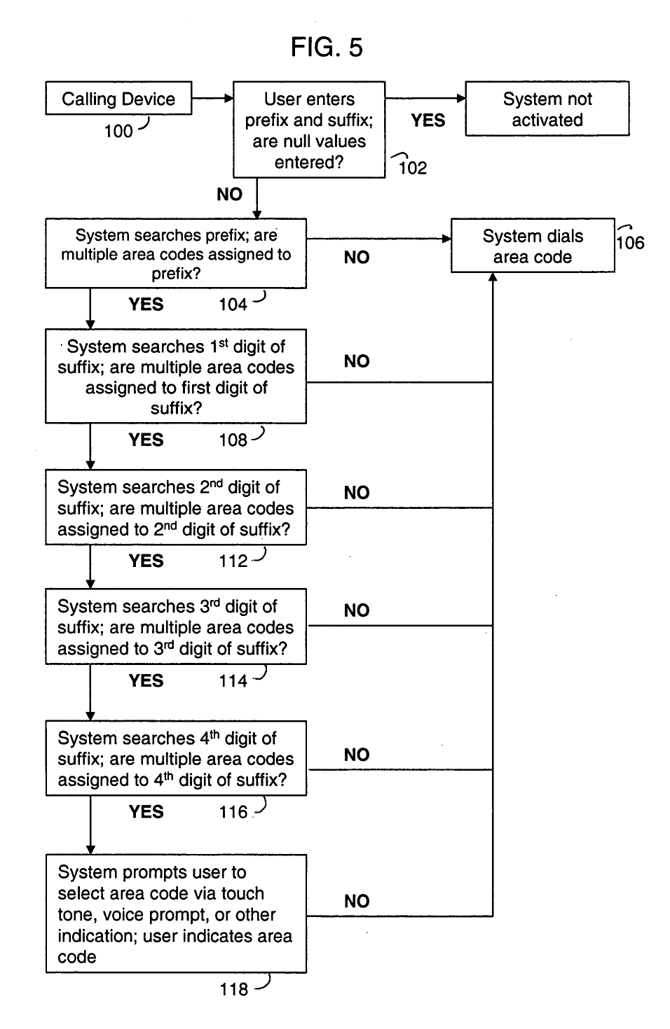

During operation of the device of FIG. 5, the user employs a calling device 100, such as a telephone, cellular telephone, fax machine, computer, wireless device, handheld communication device or the like, to enter telephone number consisting of only a three-digit prefix and a four-digit suffix, such as 867-5309, which is received by the system. If null values, such as #, *, 911, 411 and the like, are entered in accordance with block 102, the system will not be activated, and the user will be able to perform the null value's function, i.e., the system will allow the user to access voicemail, or dial directly to an emergency response dispatcher. If null values, such as #, *, 911, 411 and the like, are not entered in accordance with block 102, the intelligent number dialer system will be activated.

If no null values are entered, the system recognizes that a telephone number is being dialed and the intelligent number dialer system is activated. The system then searches the database to compare the dialed prefix, to all available area codes within the community network. For example, if the user dials prefix 867 and the suffix 5309, the system will first search the database for the prefix 867 across all area codes in the database. For example, if the community network or geographic region contains three area codes, such as 602, 480, and 523, the system searches the database to determine how many of the three area codes contain 867 prefixes. If the dialed prefix, 867, is only assigned to one area code, i.e., 602, as determined at decision block 104, the system dials the area code 602, in accordance with block 106. In this example, the system has dialed the area code (602) while user has dialed the prefix and the suffix (867-5309), and the user is connected with the telephone number 602-867-5309.

In accordance with block 104, if the prefix, for example 867, is assigned to multiple area codes, i.e., 602 and 480, the system then searches the database for area code matches of the first digit of the suffix in accordance with decision block 108. For example, if the user has dialed the prefix and suffix 867-5309, the system will search the database to determine how many area codes are assigned to the number 867-5. If the prefix (867) in combination with the first digit of the suffix (5) is not assigned to multiple area codes, the system will dial the area code, and the user will enter the remainder of the suffix in accordance with block 106. If the prefix (867) and the first digit of the suffix (5) are assigned to multiple area codes, such as 602 and 480, the system will search the database for the prefix (867), the first digit of the suffix (5) the second digit of the suffix (3) in accordance with decision block 112, and the system will search the database to determine if the numbers 867-53 are assigned to multiple area codes, such as 602 and 480. If the combination of the prefix 867, the first digit of the suffix 5, and the second digit of the suffix 3, are only assigned to one area code, e.g., 602, the system will dial the area code, in accordance with block 106. In this example, the system has dialed the area code (602) while user has dialed the prefix and the suffix (867-5309), and the user is connected with the telephone number 602-867-5309.

If the second digit of the suffix is assigned to multiple area codes, for example 602 and 480, the system search the database for the prefix (867), the first digit of the suffix (5), the second digit of the suffix (3), and the third digit of the suffix (0) in accordance with decision block 114, to determine if the third digit of the prefix in combination with the first three digits of the suffix are assigned to multiple area codes, e.g., 602 and 480. If the prefix, in combination with the first three digits of the suffix is only assigned to one area code, e.g., 602, the system will dial the area code, in accordance with block 106. In this example, the system has dialed the area code (602) while user has dialed the prefix and the suffix (867-5309), and the user is connected with the telephone number 602-867-5309.

If the prefix and first three digits of the suffix are assigned to multiple area codes, the user will search the database for the prefix (867), the first digit of the suffix (5), the second digit of the suffix (3), the third digit of the suffix (O), and the fourth digit of the suffix (9) in accordance with decision block 116, to determine if the prefix and suffix (867-5309) is assigned to multiple area codes, e.g. 602 and 480. If the prefix and suffix in combination (867-5309) is only assigned to one area code, e.g., 602, the system will dial the area code, in accordance with block 106.

If the prefix and the four digits of the suffix in combination (867-5309) is assigned to multiple area codes, e.g., 602-867-5309 and 480-867-5309, the system will prompt the user to select the correct area code. In this example, the user is prompted to select either 602 or 480, in accordance with block 118, via voice prompt, touch tone selection, sound, voice, or other indication. The user will then select the correct area code in accordance with block 118. For example, if the correct area code is 602, the user will select 602, and the system will dial the correct area code (602) in accordance with block 106. In this example, the system has dialed the area code (602) while user has dialed the prefix and the suffix (867-5309) and has completed an additional prompt, and the user is connected with the telephone number 602-867-5309.

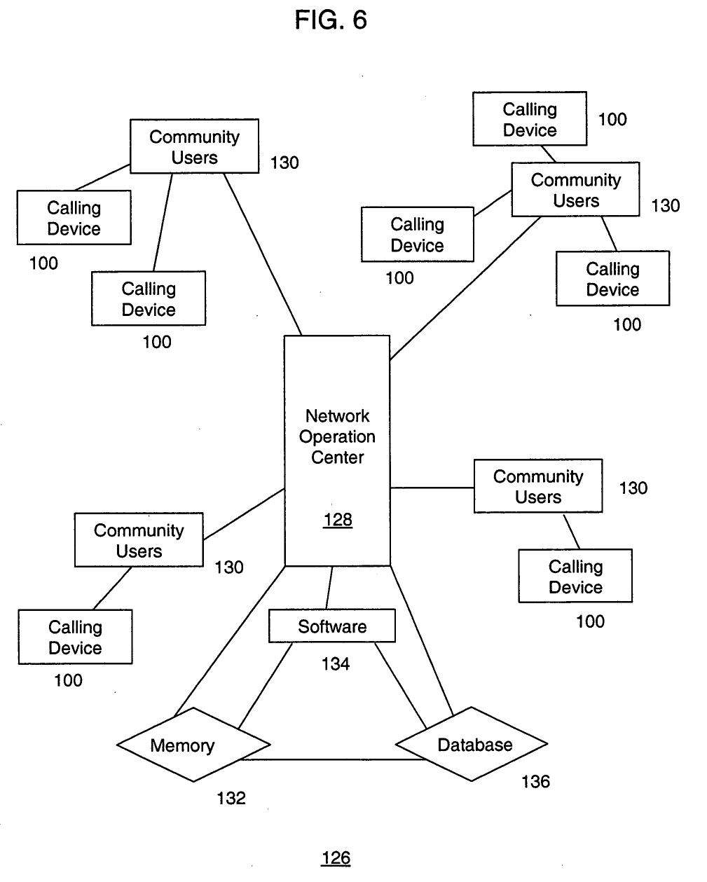

Referring now to FIG. 6, there is shown a community network 126, comprising a network operation center (NOC) 128, memory 132, software 134, a database 136, and a plurality of communities of users 130. In the embodiment of the invention in which the intelligent telephone number dialer of the present invention is incorporated within telephone, cable, television, computer, or other communication devices, the communities of users 130 are communicably connected to the network operation center via broadband connection or other types of connections.

In one embodiment of the invention, the NOC 128 serves as a central hub, and may link multiple communities of users 130, as “spokes” on the hub. Examples of such communities of users 130 include multiple neighborhoods or suburbs across a city, multiple communities within a state or other large geographic area, multiple campuses in a university system, and multiple branch offices within a corporation. Collectively each communities of users 130 is a part of a community network 126. Preferably the NOC 128 serves as the communication hub across these geographic barriers to create such a community network 126. The community of users 130 may consist of one or a plurality of users and one or a plurality of calling devices 100. The calling devices 100 may include one or a plurality of telephones, cellular telephones, fax machines, computers, wireless devices, handheld communication devices or the like.

As is also shown in FIG. 6, the network operation center 128 is communicably connected to a software or software package 134, which is capable of communicating with a memory 132 and database 136. The network operation center 128 is also communicably connected to the memory 132 and the database 136. In one embodiment of the invention, the NOC 128 is equipped with software 134 in communication with both a memory 132 and a database 136. It is envisioned that the software 134, the memory 132, and the database 136 can all reside in one physical location, e.g., in one computer processing unit, or that the software 134, the memory 132, and the database 136 can communicate from distinct physical locations, and are also communicably connected with the NOC 128. Alternatively, the software 134, the memory 132, and the database 136 can all be loaded onto the NOC 128.

In at least one embodiment of the NOC 128, as described above, the database 136 is preferably comprised of computer readable object code, and is capable of executing the method disclosed herein. The database 136 is preferably searchable and contains all of the area codes, prefixes, and suffixes of all telephone numbers registered in a municipal or other designated area, while the memory allows the NOC 128 immediate access to area codes as a user dials. The telephone numbers contained in the database 136 may be programmed into the database 136 using electronic or computer entry, or may be entered manually if necessary. It is envisioned that the database 136 is updated automatically or manually as telephone numbers are added, removed, or changed.

It is also envisioned that the software 134 may be loaded directly onto the NOC 128, or may be accessed by the NOC 128 from a discrete location. In one embodiment of the invention, when a user or device dials a seven-digit number, software 134 within the NOC 128 or remotely in communication with the NOC will search the database and select one area code from a multiplicity of area codes associated with an entered three-digit telephone number prefix, based upon the entered four-digit suffix of that telephone number. In the event that the prefix is associated with multiple area codes, in one embodiment of the invention, a visual display, voice prompt or command, tone, or other indicator signal provides an indication to the user that the prefix of the telephone number entered is associated with more than one area code, allowing the user to enter a single digit for the purpose of selecting the desired area code.

Additionally, preferably the NOC 128 can be expanded to include multiple geographic areas as needed, for example, as an expansion into outlying or suburban areas. In this embodiment of the invention, as the NOC 128 is expanded, the software, and the database will increase to include additional numbers according to the new scope of coverage.

In addition, as shown in FIG. 6, the memory 132 and the database 136 are also communicably connected with one another. In the embodiments in which the present invention is incorporated at a network operation center 128, the software 134, the memory 132 and the database 136 are interchangeably communicably connected to enable the network operation center 128, wherein the network operation center 128 has access information stored in the memory 132, database 136 via a communicable connection with the software 134.

In addition, in one embodiment of the invention, the NOC 128 will recognize as null values commonly used prompt features, star (*) and pound (#), individual voice mail prompts, such as single digits or passwords, and will also recognize community emergency and information number series, such as 911 and 411. When the NOC 128 recognizes these null values or numbers, it will not search the database, instead allowing the call to proceed directly to the local emergency or information number, allow the user to access voicemail, or proceed with telephone prompts.

It is also envisioned that the existing alphanumeric display on cellular telephones, telephones, fax machines, personal data communications devices and computers may display the complete ten-digit telephone number after the user has entered the three-digit prefix and seven-digit suffix of that number, so that the complete number may be verified before it is transmitted. Also the display, or sound synthesis, can present multiple area code selections and the user either presses the appropriate button, or speaks the appropriate number, which is interpreted by sound recognition.

1. A method for dialing a telephone number in the form of an area code, prefix, and suffix, comprising:
receiving a prefix;
comparing the prefix to a plurality of prefix values in a database, wherein the database is comprised of the plurality of prefix values, and a plurality of area codes values, wherein the plurality of prefix values correspond to one or more area codes values;
identifying the prefix value that corresponds to the received prefix;
returning the corresponding area code value for the prefix value, wherein the prefix value has one corresponding area code value;
receiving a suffix, wherein the suffix is comprised of a plurality of digits; and
dialing the telephone number, wherein the telephone number comprises the returned area code value, the received prefix and the received suffix.

2. The method in claim 1, wherein the prefix value has more than one corresponding area code value, further comprising:
comparing the received first suffix digit to a plurality of first suffix digit values in the database that correspond to the prefix value, wherein the database is further comprised of the plurality of first suffix digit values corresponding to the prefix value and one or more area code values;
identifying the first suffix digit value that corresponds to the received first suffix digit; and
returning the corresponding area code value for the first suffix digit wherein the prefix value and first suffix digit value have one corresponding area code value.

3. The method in claim 2, wherein the first suffix digit value corresponding to the prefix value has more than one corresponding area code value, further comprising:
comparing the received second suffix digit to a plurality of second suffix digit values in the database that correspond to the prefix value and first suffix digit value, wherein the database is further comprised of the plurality of second suffix digit values corresponding to the prefix value, the first suffix digit value, and one or more area code values;
identifying the second suffix digit value that corresponds to the received second suffix digit; and
returning the corresponding area code value for the second suffix digit wherein the prefix value, and the first and second suffix digit values have one corresponding area code value.

4. The method in claim 3, wherein the second suffix digit value corresponding to the prefix value and the first suffix digit value has more than one corresponding area code value, further comprising:
comparing the received third suffix digit to a plurality of third suffix digit values in the database that correspond to the prefix value and the first and second suffix digit values, wherein the database is further comprised of the plurality of third suffix digit values corresponding to the prefix value, the first and second suffix digit values, and one or more area code values;
identifying the third suffix digit value that corresponds to the received third suffix digit; and
returning the corresponding area code value for the third suffix digit wherein the prefix value, and the first, second and third suffix digit values have one corresponding area code value.

5. The method in claim 4, wherein the third suffix value corresponding to the prefix value and the first and second suffix digit values has more than one corresponding area code value, further comprising:
comparing the received fourth suffix digit to a plurality of fourth suffix digit values in the database that correspond to the prefix value and the first, second and third suffix digit values, wherein the database is further comprised of the plurality of fourth suffix digit values corresponding to the prefix value, the first and second suffix digit values, and one or more area code values;
identifying the fourth suffix digit value that corresponds to the received fourth suffix digit; and
returning the corresponding area code value for the fourth suffix digit wherein the prefix value, and the first, second, third and fourth suffix digit have one corresponding area code value.

6. The method in claim 1, wherein the prefix value has more than one corresponding area code value, further comprising, returning a menu of the corresponding area code values, wherein a user is capable of selecting one of the area code values.

7. The method in claim 5, wherein the prefix value and the first, second, third and fourth suffix values have more than one corresponding area code value, further comprising, returning a menu of the corresponding area code values, wherein a user is capable of selecting one of the area code values.

8. A computer-readable storage medium containing computer executable code for instructing a server computer to perform the steps of:
receiving a prefix;
comparing the prefix to a plurality of prefix values in a database, wherein the database is comprised of the plurality of prefix values, and a plurality of area codes values, wherein the prefix value corresponds to one or more area codes values;
identifying the prefix value that corresponds to the received prefix;
returning the corresponding area code value for the prefix value, wherein the prefix value has one corresponding area code value;
receiving a suffix, comprised of a plurality of digits; and
returning the telephone number, wherein the telephone number comprises the returned area code value, the received prefix and the received suffix.

9. The computer-readable storage medium in claim 8, further containing computer executable code for instructing a server to perform the steps of:
comparing the received first suffix digit to a plurality of first suffix digit values in the database that correspond to the prefix value, wherein the database is further comprised of the plurality of first suffix digit values corresponding to one or more prefix values and one or more area code values;
identifying the first suffix digit value that corresponds to the received first suffix digit; and
returning the corresponding area code value for the first suffix digit wherein the prefix value and first suffix digit value have one corresponding area code value.

10. The computer-readable storage medium in claim 9, further containing computer executable code for instructing a server to perform the steps of:
comparing the received second suffix digit to a plurality of second suffix digit values in the database that correspond to the prefix value and first suffix digit value, wherein the database is further comprised of the plurality of second suffix digit values corresponding to one or more first suffix digit values, one or more prefix values and one or more area code values;
identifying the second suffix digit value that corresponds to the received second suffix digit; and
returning the corresponding area code value for the second suffix digit wherein the prefix value, and the first and second suffix digit values have one corresponding area code value.

11. The computer-readable storage medium in claim 10, further containing computer executable code for instructing a server to perform the steps of:
comparing the received third suffix digit to a plurality of third suffix digit values in the database that correspond to the prefix value and the first and second suffix digit values, wherein the database is further comprised of the plurality of third suffix digit values corresponding to one or more first and second suffix digit values, one or more prefix values and one or more area code values;
identifying the third suffix digit value that corresponds to the received third suffix digit; and
returning the corresponding area code value for the third suffix digit wherein the prefix value, and the first, second and third suffix digit values have one corresponding area code value.

12. The computer-readable storage medium in claim 11, further containing computer executable code for instructing a server to perform the steps of:
comparing the received fourth suffix digit to a plurality of fourth suffix digit values in the database that correspond to the prefix value and the first, second and third suffix digit values, wherein the database is further comprised of the plurality of fourth suffix digit values corresponding to one or more first, second and third suffix digit values, one or more prefix values and one or more area code values;
identifying the fourth suffix digit value that corresponds to the received fourth suffix digit; and
returning the corresponding area code value for the fourth suffix digit wherein the prefix value, and the first, second, third and fourth suffix digit have one corresponding area code value.

13. The computer-readable storage medium in claim 8, further containing computer executable code for instructing a server to perform the step of:
returning a menu of the corresponding area code values, wherein a user is capable of selecting one of the area code values.

14. The computer-readable storage medium in claim 12, further containing computer executable code for instructing a server to perform the steps of:
returning a menu of the corresponding area code values, wherein a user is capable of selecting one of the area code values.

15. A system for dialing a telephone number in the form an area code, a prefix and a suffix, comprising:
a network operating center, wherein the network operating center is capable of receiving a prefix;
comparing the prefix to a plurality of prefix values in a database, wherein the database is comprised of the plurality of prefix values, and a plurality of area codes values, wherein the prefix value corresponds to one or more area codes values;
identifying the prefix value that corresponds to the received prefix;
returning the corresponding area code value for the prefix value, wherein the prefix value has one corresponding area code value;
receiving a suffix, comprised of a plurality of digits; and
dialing the telephone number, wherein the telephone number comprises the returned area code value, the received prefix and the received suffix.

16. The system in claim 15, wherein the network operating center is further capable of:
comparing the received first suffix digit to a plurality of first suffix digit values in the database that correspond to the prefix value, wherein the database is further comprised of the plurality of first suffix digit values corresponding to one or more prefix values and one or more area code values;
identifying the first suffix digit value that corresponds to the received first suffix digit; and
returning the corresponding area code value for the first suffix digit wherein the prefix value and first suffix digit value have one corresponding area code value.

17. The system in claim 16, wherein the network operating center is further capable of:
comparing the received second suffix digit to a plurality of second suffix digit values in the database that correspond to the prefix value and first suffix digit value, wherein the database is further comprised of the plurality of second suffix digit values corresponding to one or more first suffix digit values, one or more prefix values and one or more area code values;
identifying the second suffix digit value that corresponds to the received second suffix digit; and
returning the corresponding area code value for the second suffix digit wherein the prefix value, and the first and second suffix digit values have one corresponding area code value.

18. The system in claim 17, wherein the network operating center is further capable of:
comparing the received third suffix digit to a plurality of third suffix digit values in the database that correspond to the prefix value and the first and second suffix digit values, wherein the database is further comprised of the plurality of third suffix digit values corresponding to one or more first and second suffix digit values, one or more prefix values and one or more area code values;
identifying the third suffix digit value that corresponds to the received third suffix digit; and
returning the corresponding area code value for the third suffix digit wherein the prefix value, and the first, second and third suffix digit values have one corresponding area code value.

19. The system in claim 18, wherein the network operating center is further capable of:
comparing the received fourth suffix digit to a plurality of fourth suffix digit values in the database that correspond to the prefix value and the first, second and third suffix digit values, wherein the database is further comprised of the plurality of fourth suffix digit values corresponding to one or more first, second and third suffix digit values, one or more prefix values and one or more area code values;
identifying the fourth suffix digit value that corresponds to the received fourth suffix digit; and
returning the corresponding area code value for the fourth suffix digit wherein the prefix value, and the first, second, third and fourth suffix digit have one corresponding area code value.

20. The system in claim 15, wherein the network operating center is further capable of:
returning a menu of the corresponding area code values, wherein a user is capable of selecting one of the area code values.

21. The system in claim 20, wherein the network operating center is further capable of:
returning a menu of the corresponding area code values, wherein a user is capable of selecting one of the area code values.

22. An intelligent telephone number dialer for dialing a telephone number in the form an area code, a prefix and a suffix, comprising:
a microprocessor capable of processing telephone number digits;
a non-volatile memory, in communication with the microprocessor, wherein the non-volatile memory is capable of storing a searchable database comprised of a plurality of area codes values and a plurality of prefix values, wherein the plurality of prefix values correspond to one or more area code values;
wherein the microprocessor being responsive to receipt of a prefix, is capable of comparing the prefix to a plurality of prefix values in the database; identifying the prefix value that corresponds to the received prefix; returning the corresponding area code value for the prefix value, wherein the prefix value has one corresponding area code value; receiving a suffix, comprised of a plurality of digits, and returning the telephone number, wherein the telephone number comprises the returned area code value, the received prefix and the received suffix.

23. The intelligent telephone number dialer in claim 22, wherein the microprocessor is further capable of comparing the received first suffix digit to a plurality of first suffix digit values in the database that correspond to the prefix value, wherein the database is further comprised of the plurality of first suffix digit values corresponding to one or more prefix values and one or more area code values; identifying the first suffix digit value that corresponds to the received first suffix digit; and returning the corresponding area code value for the first suffix digit wherein the prefix value and first suffix digit value have one corresponding area code value.

24. The intelligent telephone number dialer in claim 23, wherein the microprocessor is further capable of comparing the received second suffix digit to a plurality of second suffix digit values in the database that correspond to the prefix value and first suffix digit value, wherein the database is further comprised of the plurality of second suffix digit values corresponding to one or more first suffix digit values, one or more prefix values and one or more area code values; identifying the second suffix digit value that corresponds to the received second suffix digit; and returning the corresponding area code value for the second suffix digit wherein the prefix value, and the first and second suffix digit values have one corresponding area code value.

25. The intelligent telephone number dialer in claim 24, wherein the microprocessor is further capable of comparing the received third suffix digit to a plurality of third suffix digit values in the database that correspond to the prefix value and the first and second suffix digit values, wherein the database is further comprised of the plurality of third suffix digit values corresponding to one or more first and second suffix digit values, one or more prefix values and one or more area code values; identifying the third suffix digit value that corresponds to the received third suffix digit; and returning the corresponding area code value for the third suffix digit wherein the prefix value, and the first, second and third suffix digit values have one corresponding area code value.

26. The intelligent telephone number dialer in claim 25, wherein the microprocessor is further capable of comparing the received fourth suffix digit to a plurality of fourth suffix digit values in the database that correspond to the prefix value and the first, second and third suffix digit values, wherein the database is further comprised of the plurality of fourth suffix digit values corresponding to one or more first, second and third suffix digit values, one or more prefix values and one or more area code values; identifying the fourth suffix digit value that corresponds to the received fourth suffix digit; and returning the corresponding area code value for the fourth suffix digit wherein the prefix value, and the first, second, third and fourth suffix digit have one corresponding area code value.

27. The intelligent telephone number dialer in claim 26, wherein the microprocessor is further capable of returning a menu of the corresponding area code values, wherein a user is capable of selecting one of the area code values.

28. The intelligent telephone number dialer in claim 22, wherein the microprocessor is further capable of returning a menu of the corresponding area code values, wherein a user is capable of selecting one of the area code values.

29. The intelligent telephone dialer in claim 22 wherein the microprocessor is operatively coupled with a network operating center.

30. The intelligent telephone dialer in claim 22, wherein the microprocessor is capable of effectuating the dialing of the telephone number.
